(19) United States
(12) Patent Application Publication
(10) Pub. No.: US 2013/0236985 A1
(43) Pub. Date: Sep. 12, 2013

(54) METHOD AND DEVICE FOR OPTICAL EXAMINATION

(71) Applicants: Gert Blankenstein, Arlington, MA (US); Dirk Kurowski, Gevelsberg (DE)

(72) Inventors: Gert Blankenstein, Arlington, MA (US); Dirk Kurowski, Gevelsberg (DE)

(21) Appl. No.: 13/698,111

(22) PCT Filed: May 26, 2011
(86) PCT No.: PCT/EP2011/058635

§ 371 Date: Jan. 4, 2013

(30) Foreign Application Priority Data
May 31, 2010 (EP) 10005631.6

(51) Int. Cl. G01N 21/64

(52) U.S. Cl. CPC G01N 21/6428
USPC 436/501; 422/69

(57) ABSTRACT

A method and a device for the optical examination of a surface region are proposed. Fluorescence measurement is used to determine the amount of a substance bound to the surface region. Light interference is shut out thanks to the surface region being covered with an optically active liquid which filters, reflects, scatters and/or absorbs light with a wavelength at least substantially corresponding to the light radiated in and/or out.

The present invention relates to a process for optical examination according to the preamble of claim 1 and a device according to the preamble of claim 14.

The present invention is concerned with the optical examination of a surface region, preferably for the optical detection of a reaction occurring thereon or a substance bound thereto, particularly with diagnosis using microfluidic samples. In particular the present invention relates to preferably miniaturised immunoassays, i.e. the examination of samples using antibodies. Particularly preferably, the present invention relates to so-called cartridge designs, i.e. small, particularly box-shaped devices for investigating a preferably liquid sample or for carrying out immunoassays.

In an immunoassay in the sense of the present invention an analyte of a sample which is to be determined is bound to a surface region, particularly by means of an antibody. The binding of the analyte or other substance by means of an antibody is referred to as an immunoassay reaction in the present invention.

Preferably, before or after binding to the surface region the analyte is linked to a detectable, more particularly fluorescent conjugate or other detection partner. For example, a complex is formed from the analyte and the conjugate, which binds to the immobilised antibody on the surface region. However, it is also theoretically possible for the analyte which is to be examined or determined to bind to the antibody and for the conjugate to bind to antibodies which are not occupied by an analyte. All kinds of combinations and other types of binding and binding sequences are also possible.

The detection of the conjugate or other detection partner for determining the analyte takes place optically, particularly by measuring luminescence or fluorescence. This is known, for example, from WO 02/08762 A1.

In WO 02/08762 A1 a surface region which is to be examined is irradiated with laser light and any light radiated off, namely fluorescent light emitted, is detected by means of a CCD camera. A band pass filter is used to block the laser light while the light emitted by fluorescent molecules is allowed through. This improves the signal-to-noise ratio considerably and is important particularly for weak signals, i.e. low emission strengths.

Principally, a band filter of this kind is arranged directly in front of the camera or other receiver for the radiated or emitted light. However, this method cannot be used to eliminate undesirable interference signals or background light or the like.

WO 02/14926 A2 relates to fluidic systems in which light beams are manipulated by fluids which reflect, bend, absorb, optically filter or scatter the light in order to produce optical switches or filters, for example. However, WO 02/14926 A2 Is not concerned with the optical examination of surfaces or the detection of substances on surfaces.

The aim of the present invention is to provide a method and a device for optically examining a surface region, which gives improved optical detection, particularly for detecting a reaction such as an immunoassay reaction or for detecting an analyte.

The above aim is achieved by a method according to claim 1 or a device according to claim 14. Advantageous further features are the subject matter of the sub-claims.

According to the proposal, the surface region that is to be examined is covered by an optically active liquid which filters, reflects, scatters, polarises and/or absorbs light with a wavelength at least substantially corresponding to the light which is radiated in and/or out. Thus the surface region can be examined optically, particularly from the side remote from the liquid, and the desired optical detection or determination can be carried out, particularly preferably in the form of a measurement of luminescence or fluorescence, while the optically active liquid is surprisingly able to effectively suppress or shut out unwanted interference signals such as reflections from an opposite wall of the chamber, emissions of substances on other walls, emissions of the wall material, background influences or the like. In this way an exceptionally improved signal to noise ratio can be achieved, in particular. Furthermore, a significantly improved linearity can be achieved in the detection or determination of an analyte or when carrying out an immunoassay. The light is preferably irradiated through the wall that forms or carries the surface region, i.e. particularly from the side remote from the liquid. The light radiated out is preferably also detected through this wall, i.e. particularly on the side remote from the liquid. Accordingly there is no need to pass light through the liquid. In this way it is possible to avoid, or at least minimise, further unwanted excitations or emissions or other interference in deeper regions—for example on the base of a chamber.

Particularly preferably, the optical examination or detection is carried out by measurement of luminescence or fluorescence. Particularly preferably, UV light is radiated in. This makes the method largely independent of any disruptive light sources.

The optically active liquid preferably contains at least one dye and/or pigments or particles. Thus it is possible to obtain a very effective absorption or scattering or filtering, particularly in the visible range in which the light radiated out or emitted is usually or preferably located, and/or in the UV range in which the light radiated in is usually or preferably located.

Particularly preferably, the optically active liquid is a washing liquid or other reaction liquid which is used particularly for forming and/or binding a substance and/or for an immunoassay reaction. Thus, at minimal cost, for example by colouring the washing liquid, a substantial improvement in optical examination or detection can be achieved. However, any other liquid may also be used.

In order, in particular, to achieve an adequate or good absorption or filter effect, the liquid covers the surface region or detection region that is to be examined, preferably with a layer thickness of more than 0.1 μm, preferably more than 1 μm, more particularly more than 10 μm, preferably more than 50 μm, particularly preferably more than 100 μm.

The device according to the invention is embodied in particular for carrying out the method described above and/or as an immunoassay. For this purpose it comprises an in particular microfluidic detection chamber which is in turn provided with a surface region on the chamber side through at least one transparent wall. The surface region or a substance located or bound thereon, such as a detection partner or conjugate, can be irradiated with light radiated in, and/or light radiated out can be detected. The covering of the surface region with the optically active liquid is preferably carried out by filling the detection chamber with the liquid. This constitutes a very easy method.

By “microfluidic” are meant, according to the invention, volumes of preferably less than 10 ml, particularly preferably less than 1 ml, and/or chamber or liquid cross-sections (maximum or hydraulic diameter) of preferably less than 2 mm, particularly preferably less than 500 μm.

As already mentioned, the surface region to be examined serves particularly for at least detecting or binding a substance. This substance may be an analyte of a sample or a complex formed therefrom or a reaction product dependent thereon and/or a reagent which interacts or binds with the sample, an analyte of the sample, a complex thereof or the like.

For example, the reagent may interact or bind with a complex of the analyte or with a reaction product dependent on the analyte. Preferably the reagent itself is fixed or immobilised in or on the surface region. In particular, it may be provided with an immobilised antibody which interacts with, most preferably binds to, an analyte of the sample or a complex containing the analyte. In this case the reagent is formed by the antibody which interacts directly or indirectly with the analyte, particularly with a complex or the like that contains the analyte. However, other interactions or reactions can also be carried out, for example modification of the reagent or surface region or dissolving of the reagent. The term “interaction” should therefore preferably be interpreted broadly according to the present invention.

Preferably, the surface region is at least substantially flat or smooth and/or is arranged on an at least substantially flat fluid side or chamber interior of a chamber wall. This helps to ensure good or defined detection or determination of an analyte and a simple structure and course of the reaction.

By the term “determination” according to the invention is preferably meant the detection of an interaction, modification or reaction on the surface region and/or the binding of a substance such as an analyte, complex or the like, on the surface region, in order to allow a preferably qualitative and/or quantitative examination of the sample, particularly a qualitative and/or quantitative measurement of at least one analyte of the sample. For this purpose, optical detection or measurement is carried out, in particular, on a preferably fluorescent detection partner, conjugate or the like to allow the measurement to take place. Optical detection is most preferably carried out using the measurement of luminescence or fluorescence.

Further aspects, features, properties and advantages of the present invention will become apparent from the claims and the following description of a preferred embodiment with reference to the drawings, wherein:

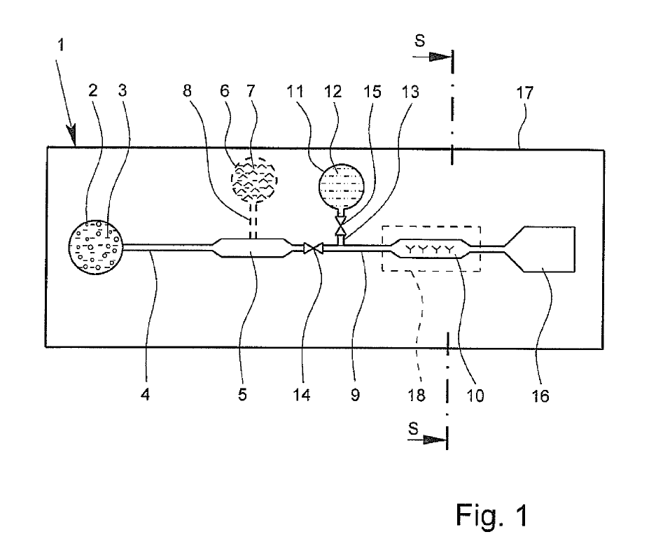

FIG. 1 is a schematic plan view of a proposed device with a detection chamber;

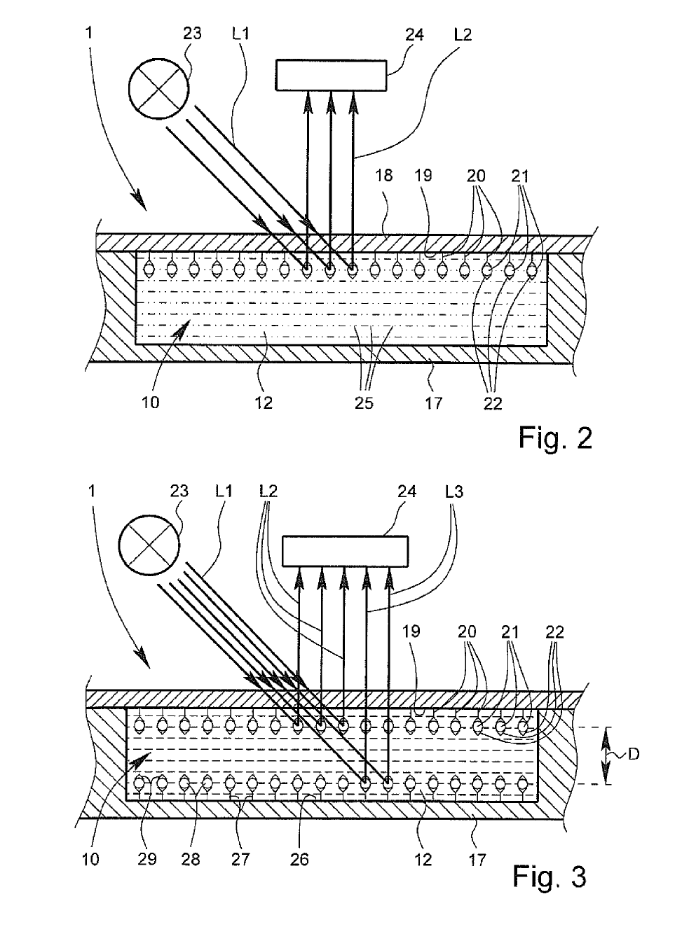

FIG. 2 is a schematic cross-section of the detection chamber during an investigation; and

FIG. 3 is a schematic cross-section of the detection chamber during another investigation.

In the Figures, the same reference numerals are used for identical or similar parts and components, with corresponding or similar advantages and properties being obtained, even if the description is not repeated.

FIG. 1 shows a device 1 as proposed, in schematic plan view. The device 1 is preferably at least substantially box-shaped, plate-shaped, flat, thin and/or planar in construction.

The proposed device 1 preferably takes the form of an immunoassay or is designed for carrying out an immunoassay reaction.

The device 1 in the embodiment shown preferably has a sample holder 2 for a liquid sample 3. It is used in particular for investigating the sample 3.

The sample 3 is preferably liquid—particularly at least partially or substantially, while individual analytes or substances such as proteins or the like to be detected in the sample 3 are not or may not themselves be liquid.

The sample 3 may be, for example, a body fluid, saliva, blood or the like for examination. The device 1 or sample holder 2 may, for example, contain a filter for separating blood plasma or the like and examining it in the device 1. However, other design solutions are also possible.

In the following description, for reasons of simplicity, reference will usually only be made to the sample 3, even if what is meant is constituents of the sample 3 which are being further processed or examined in the device 1, for example after blood cells have been filtered off.

In the embodiment shown the device 1 preferably has a channel 4 which conveys the sample 3 or a component thereof, such as blood plasma, particularly to a mixing chamber 5 of the device 1.

In the mixing chamber 5 the sample 3 is preferably mixed or combined with a detection partner, especially a conjugate. The detection partner or the conjugate may combine particularly with an analyte that is to be determined, in particular forming a complex. This step is referred to as incubation.

The detection partner or the conjugate may, for example, be present in dried form in the mixing chamber 5 or in another part of the device 1 and may be dissolved by the sample 3 supplied.

However, the detection partner or conjugate may also if required be present or provided or supplied in liquid form. FIG. 1 schematically shows a receptacle 6 for a detection liquid 7 which is connected to the mixing chamber 5 through a channel 8, for example. Thus, for example, the sample 3 and the detection liquid 7 may be combined and mixed or mingled in the mixing chamber 5 to achieve the desired incubation.

However, in principle, other arrangements and/or procedures are also possible.

In the embodiment shown the sample 3 which has preferably already been incubated is supplied to a detection chamber 10 of the device 1 through a channel 9. In the detection chamber 10 a surface-bound reaction or immunoassay reaction takes place, in particular. The detection chamber 10 serves particularly for optical examination or detection of the reaction or the sample 3 or a surface region, particularly preferably for the optical detection or measurement of an analyte of the sample 3 or some other substance or other reactions or the like which are particularly connected therewith. This will be discussed in more detail hereinafter.

In particular, in the detection chamber 10, a substance such as the analyte or the like which is to be determined binds to the surface region, particularly preferably by means of or on antibodies. Most preferably, the antibodies are immobilised on the surface region in the detection chamber 10. However, other design or reaction embodiments are also possible.

In the embodiment shown the device 1 is preferably embodied such that after the above-mentioned binding has occurred or at the end of the immunoassay reaction or other reaction in the detection chamber 10 a washing step or, generally speaking, rinsing can take place. For this purpose the device 1 preferably comprises a receptacle or a reservoir 11 for a washing liquid 12 or other rinsing liquid. The reservoir 11 is directly or indirectly connected to the detection chamber 10 via a channel 13, for example; in this embodiment via the channel 9.

For controlling the desired progress of the reaction or the currents of liquid, the device 1 may have suitable valves. In the embodiment shown, for example, a valve 14 may be provided (particularly in channel 9) for controlling the supply of the sample 3 and optionally reaction liquid into the detection chamber 10, and/or a valve 15 may be provided (particularly in channel 13) for controlling the supply of washing liquid 12 into the detection chamber 10. In the embodiment shown, the channel 13 preferably opens into the channel 9 downstream of the valve 14. However, in principle, other arrangements, fluidic connections or the like are also possible. For example, valves may also be provided in the channels 4 and 8.

In a preferred process, first of all the sample 3 that is to be investigated is incubated with the detection partner or conjugate in the mixing chamber 5 for a predetermined time and then conveyed into the detection chamber 10, for example by opening the valve 14. There, it is possible for the analyte, a complex formed from analyte and conjugate or some other substance to bind, for example. After an in particular predetermined time, washing or rinsing is then carried out, particularly by opening the valve 15. The excess volumes of fluid can be conveyed from the detection chamber 10 into a connected excess reservoir 16, often referred to as the waste, of the device 1. However, other design solutions are also possible.

The device 1 or detection chamber 10 is, in particular, a microfluidic system. Preferably, individual liquids or all the liquids flow through the device 1 at least in some areas as a result of capillary forces, most preferably by means of capillary forces alone. However, in addition or alternatively, other forces may come into effect, for example caused by pressure differences, in particular in order to permit or ensure a desired progress of the process or reaction. For example, individual valves can be opened by the exertion of a corresponding pressure, for example on the receptacle 6 or reservoir 11.

The device 1 or detection chamber 10 is preferably made up of a base part or lower part 17 which, in the embodiment shown, is particularly preferably embodied as an injection-moulded part and/or channel plate with corresponding recesses, depressions or the like. Provided therein are, in particular, recesses for the sample holder 2, the channel 4, the mixing chamber 5, the receptacle 6, the channel 8, the channel 9, the detection chamber 10, a connecting channel from the detection chamber 10 to the overflow reservoir 16 and/or the overflow reservoir 16 itself.

The base part or lower part 17 is preferably covered by an upper part or a lid, particularly at least substantially over its entire surface and/or right through, while for example a breach or opening may be formed in the region of the sample holder 2 for receiving the sample 3 and/or, for example, an aerating or venting opening (vent) may be formed in particular in connection with the overflow reservoir 16. The same applies to the receptacle 6 for the detection liquid 7 and/or the reservoir 11 and the washing liquid 12. However, for example, the receptacle 6 and the reservoir 11 may if necessary also be covered or closed off by the upper part or lid element or some other cover, particularly after the detection liquid 7 or washing liquid 12 have been added.

In the embodiment shown in FIG. 1 only one lid element 18 is shown in the region of the detection chamber 10, particularly for totally covering the detection chamber 10. In this case or generally speaking, the upper part of the lid may thus also be made in several parts.

Generally it should be noted that the upper part or lid element 18 may if necessary be formed by film or any other suitable material. The connection to the base part or lower part 17 is preferably achieved by adhesion, sealing, welding, laminating, pressing, clamping, riveting and/or by any other suitable method.

Corresponding air holes and/or vents may be provided as necessary in the device 1, in the lower part 15 and/or in the lid element 18, but are not shown for reasons of simplicity.

The device 1 is designed particularly for optical investigation or detection. A corresponding proposed process for optical examination of a surface region or for optical detection or determination of an analyte or other substance or an immunoassay reaction are described in more detail hereinafter with reference to FIGS. 2 and 3. FIGS. 2 and 3 show schematic cross-sections of details of the detection chamber 10 on the line S in FIG. 1.

FIG. 2 schematically shows the detection chamber 10 during a first investigation of a surface region 19 of the detection chamber 10 or a wall of the detection chamber 10. The wall or the surface region 19 is preferably formed by the lid element 18 in the embodiment shown. The wall or the lid element 18 is preferably transparent (enough to enable optical investigation or detection).

The surface region 19 to be investigated is located on the fluid side of the detection chamber 10. The wall or surface region 19 represents in particular a direct boundary of the inner space of the detection chamber 10 or for liquid.

In the embodiments shown in FIGS. 2 and 3 the detection chamber 10 is filled with the washing liquid 12 for or during the optical examination. However, the detection chamber 10 may theoretically also be filled with any other liquid for the optical examination. Accordingly, only the term “liquid 12” is used hereinafter in this respect.

In the embodiment shown in FIG. 2 an immunoassay reaction has preferably already taken place in the detection chamber 10 or a substance to be detected is already bound to the surface region 19. In particular, the surface region 19 is (at least partially) provided with immobilised binding partners, in this case antibodies 20. Bound to this surface region 19 is a substance to be detected or an analyte 21 with an associated detection partner or conjugate 22 or a complex formed therefrom or the like. This so-called “sandwich construction” is shown in highly schematic and magnified form in FIG. 2.

The immunoassay reaction proceeds particularly as follows, in the embodiment shown: the sample 3 with the analyte 21 that is to be detected is incubated in particular in the mixing chamber 5 with the associated detection partner, in this case the conjugate 22, i.e. they are mixed or brought into contact. Analyte/conjugate complexes could be formed, in particular. However, other interactions or reactions may also take place. As already mentioned, the detection partners or conjugates 22 may be present in the mixing chamber 5 in dried-on form or pre-prepared in some other way. In the former case, they are then redissolved by the sample 3 or other liquid. Alternatively, the detection partners or conjugates 22 may also be added to or mixed into the sample 3 through the detection liquid 7 optionally provided, particularly directly into the mixing chamber 5, as already mentioned. The mixture or the sample 3 is then conveyed into the detection chamber 10 particularly after incubation and/or for the purpose of (further) incubation.

In the detection chamber 10 the binding partners or antibodies 20 are preferably already bound to or immobilised on the surface region 19. The substances or analytes 21 to be detected in the analyte/conjugate complexes or the like are then bound to the antibodies 20 or to the surface region 19. This constitutes in particular a surface-bound reaction or immunoassay reaction in the sense of the present invention.

Then, non-bound detection partners, conjugates 22 and, more particularly, other substances which may interfere with the optical examination are preferably eliminated from the detection chamber 10 using the washing liquid 12 by suitably rinsing the detection chamber 10 with the washing liquid 12. However, the substances or analytes 21 to be detected and the detection partners or conjugates 22 which are to be detected optically remain bound to the surface region 19, so that the actual optical detection or measurement can then take place.

The immunoassay reaction described hereinbefore may also be carried out differently. For example, first the analytes 21 may bind to the antibodies 20 and only then may the detection partners or conjugates 22 bind to the analytes 21 which are already bound. In this case the sample 3 and detection liquid 7 may be passed through the detection chamber 10 one after the other, for example. Alternatively or additionally, other courses of the reaction and process are also possible. For example, the antibodies 19 may selectively be occupied by different substances such as the analytes 21 and conjugates 22 or different conjugates 22. For example, certain detection partners or conjugates 22 may bind only to free antibodies 20. Different bonds, reactions and/or interactions are also possible. Preferably, the term “binding” should be understood broadly, to encompass not only chemical compounds but also other forms of addition, adhesion or the like.

Alternatively and additionally it is also possible that different reaction partners, such as non-bound detection partners or conjugates 22, are not eliminated from the detection chamber 10 by rinsing but are, for example, simply moved away from the surface region 19, for example by being moved magnetically or electrically into another region of the detection chamber 10, and/or are bound in or on other regions.

By means of the proposed device 1 and the proposed method, optical investigation of the surface region 19 takes place, in particular, in order to detect or measure the bound detection partners or conjugates 22 so as thereby to determine the quality or quantity of the substance or analyte 21 which is to be detected or the content thereof in the sample 3. In particular, the content of the analyte 21 or other substance in the sample 3 can thus be measured or determined.

However, the optical investigation may also serve other purposes, particularly a different optical detection.

The optical examination relates in particular to the surface region 19, particularly comprising or relating to the transition to the liquid 12 or an interface region of the liquid 12 close to the surface, particularly of less than 50 or 100 nm.

For optical examination a light source 23 and then optical sensor 24 are preferably used. The surface region 19 or a substance bound thereto, such as the detection partner or the conjugate 22, is irradiated with light L1 shone in and the light L2 radiated out is detected by the sensor 24. In particular, luminescence or fluorescence is measured. The angle of irradiation of the light L1 shone in and the angle of the main direction of detection for the radiated-out light L2 which is to be detected preferably differ, so as to shut out reflected light, i.e. so that it is not detected by the sensor 24.

In the embodiment shown it is apparent that the irradiation of the light L1 is diagonal and the direction or main direction of detection of the emitted light L2 is at least substantially perpendicular—to the main direction of the detection chamber 10 or device 1 and/or to the flat side of the device 1 and/or to the surface area of the surface region 19. However, this may also be carried out conversely or in some other manner.

Preferably, light L1 from the UV range, i.e. UV light, is shone in, for example with a wavelength of 250-400 nm, particularly substantially 350 nm. The light source 23 is preferably a UV light source.

The light L2 radiated out or emitted, or the light L2 which can be detected by the sensor 24, is preferably in the visible range in the embodiment shown, particularly in the green range, and/or preferably has a wavelength of 500-650 nm, more particularly substantially 550 nm.

The wavelengths or wavelength ranges used may, however, vary considerably depending on the reaction partners, detection partners or the like that are involved and may accordingly be adapted to the particular requirements. In particular, the wavelength or wavelength range of the emitted light L2 which is relevant for the detection is highly dependent on the detection partner or conjugate 22 used and may vary accordingly. Particularly preferably, the detection partner or conjugate 22 contains a lanthanoide, particularly Sm, Eu or Tb.

In the embodiment shown a time-resolved fluorescence measurement is particularly preferably carried out. Alternatively or additionally the light L2 radiated out or emitted may also be spectrally resolved.

The irradiation of the light L1 and/or the detection of the emitted or radiated light L2 is or are preferably carried out through the wall which forms or carries the surface region 19, i.e. through the lid element 18, in the embodiment shown.

On the chamber side, the surface region 19 is covered by the liquid 12 for the optical examination, i.e. during the optical examination or fluorescence measurement. The liquid 12 is, according to the proposal, optically active so as to filter, reflect, scatter, polarise and/or absorb light with a wavelength at least substantially corresponding to the light L1 or L2 which is irradiated in and/or out.

The optically active liquid 12 ensures, in particular, that the light L1 radiated in can penetrate as little as possible or not at all into the liquid 12 or at least cannot penetrate into the liquid 12 as far as an opposite surface region 26 or base or to the base part or lower part 17. Thus, corresponding reflections and/or excitations of the fluid 12 or of substances contained in the fluid 12 and/or of the opposing surface region 26 or base or of substances disposed thereon, detection partners, particularly conjugates 22 or the like adhering thereto, can be reduced or prevented altogether. Moreover, unwanted excitations of the wall material in the opposite wall which in this case is formed by the base or lower part 17 can be reduced or even prevented.

Alternatively or additionally, the optically active liquid 12 ensures that any interference signals present are blanked out. By the term “interference signals” are meant in this case unwanted irradiated light which may falsify or be superimposed upon the detection or measurement of the light L2 actually radiated by the conjugates 22 on the surface region 19 under investigation. In particular, the unwanted interference signals may be, for example, light radiated from the background through the often transparent base or lower part 17 into the liquid 12 or through it. Moreover, the interference signals may be emitted light which is emitted by the wall material of the base or lower part 17 or by another wall portion of the detection chamber 17 or the like, particularly after being suitably excited by the irradiated light L1. Moreover, the interference signals may also be light which is emitted by detection partners or conjugates 22 remaining in the detection chamber 10—particularly after rinsing—particularly after being suitably excited by the irradiated light L1. In practice, what happens is that even after washing or rinsing some detection partners or conjugates 22 may be present in the liquid 12 and/or adhere to other walls or surfaces of the detection chamber 10, such as the opposite surface or base region or on the base or lower part 17.

As a result the optically active liquid 12 ensures that a substantially better signal to noise ratio can be achieved in the optical examination or fluorescence measurement. In particular, undesirable interference signals can be substantially reduced very effectively by the optically active liquid 12. The optical investigation or measurement can accordingly be carried out substantially more accurately. In particular, substantially lower contents of the analyte 21 in the sample 3 can be determined with substantially more accuracy. Moreover, a significantly improved linearity can thus be achieved in the detection or determination of the analyte 21 or in carrying out an immunoassay.

The liquid 12 in the detection chamber 10 is preferably optically activated or active as a result of the addition of a dye and/or pigments or particles 25 in order to achieve the desired optical properties as described above. The dye, pigment or particles 25 may also be any desired combination or mixture of different substances.

Tests have shown that an azo dye or red dye such as amaranth (E123), for example, is highly suitable. This can achieve an improvement in the signal to noise ratio of more than factor 5, particularly when irradiating with UV light and in measurements in the green range, particularly preferably at about 550 nm.

Alternatively or additionally, however, it is also possible to use pigments and/or particles particularly with a mean diameter of about 10-30 nm and/or with or consisting of titanium dioxide or the like. Using very fine titanium dioxide nanoparticles (E171) or other nanoparticles it is possible, for example, to achieve absorption in the UV range, while the liquid 12 itself may remain transparent in the visible range.

Preferably the optically active liquid 12 is totally or at least substantially saturated with the dye, particularly by more than 50%. The same is preferably also true when pigments or particles 25 are used. Thus, even when liquids of low thickness are used, the desired optical property of the liquid 12 may be achieved to a sufficient degree.

The surface region 19 to be examined is covered with the optically active liquid 12 in a layer thickness D (shown in FIG. 3) of preferably more than 0.1 μm, advantageously more than 1 μm, more particularly more than 10 μm, preferably more than 50 μm, particularly preferably about 100 μm or more, in order to be able to ensure that the liquid 12 has a sufficiently powerful optical effect. The desired optical effect of the liquid 12 can be intensified by other particles or substances contained therein which ensure, for example, scattering, reflection or refraction of the light, so that if desired a correspondingly lower concentration of the dye or of the particles/pigments 25 and/or a correspondingly lower layer thickness D may be sufficient to achieve the desired or necessary optical effect of the liquid 12, particularly the at least substantial screening out or suppression of interference signals.

The optically active liquid 12, according to one aspect of the present invention, is preferably used as an optically neutral background for detecting the light L2 radiated out or emitted, particularly for fluorescence measurement.

Alternatively or additionally, the optically active liquid 12 is preferably used as an optical filter for light behind the surface region 19, i.e. on the side remote from the detection or measuring side.

As already mentioned, the optically active liquid 12 may be, in particular, a washing liquid 12 provided for the immunoassay reaction or some other reaction. However, theoretically the optically active liquid 12 may be any other reaction liquid which is used in particular for the formation and/or binding of the substance and/or for an immunoassay reaction. Moreover, the optically active liquid 12 may also be a liquid used additionally, independently of the reaction or binding of a substance or the like that is to be detected, which is optionally used or introduced into the detection chamber 10 only or additionally for the purposes of optical examination.

Alternatively or additionally, corresponding dyes, pigments and/or particles may also be added to or dissolved in the liquid 12 only in the detection chamber 10. For example, the dyes, pigments and/or particles 25 may be present in dried form in the detection chamber 10 and dissolved, or they may be added in some other way.

Furthermore, it is theoretically possible for the optically active liquid 12 to be coated with an optically inactive liquid. In this case the optically active layer of liquid is preferably directly adjacent to the surface region 19. However, if required, an optically inactive layer of liquid may also be present between the optically active layer of liquid and the surface region 19 that is to be examined.

Moreover it is theoretically possible for the optical properties of the optically active liquid 12 and/or the concentration of the dyes, pigments and/or particles 25 to vary spatially, particularly over the thickness D of the detection chamber 10 or perpendicularly to the surface region 19.

In principle, the optical properties of the optically active liquid 12 may also be varied in controlled manner, for example in order to enable selective detection or measurement of light L2 radiated from different spatial areas and/or in different wavelength ranges. For example, a dye, pigment or particles 25 may additionally be added during an optical examination or measurement or between two optical examinations or measurements, in order to vary the optical properties of the optically active liquid 12 in the desired manner, or the optically active liquid 12 may be replaced by an optically inactive liquid or vice versa.

It will hereinafter be explained by reference to FIG. 3 how the optically active liquid 12 can be used in order, for example, to selectively (optically) cover an in particular opposite (additional) surface region 26 so as to selectively prevent or at least minimise irradiation of the surface region 26 or a substance arranged thereon and/or radiation therefrom. Starting from the basic examination already described in FIG. 2 only essential differences will be described below, with the result that the comments or explanations provided hitherto continue to apply accordingly or in a supplementary capacity.

The optical examination or measurement shown in FIG. 3 is particularly carried out as a supplement (before or after) to the optical examination of the surface region 19 shown in FIG. 2. In the alternative embodiment according to FIG. 3, the liquid 12 present in the detection chamber 10 during the optical examination is in fact not optically active. For this purpose the optically active liquid 12 according to FIG. 2 may be replaced by a non-optically active liquid 12 according to FIG. 3, or vice versa.

Accordingly, without the optical effect, the additional surface region 26 which is opposite the surface region 19 and is separated therefrom by the liquid 12 can also be optically examined. The embodiment shown in FIG. 3 schematically shows that an additional analyte 28 with an additional conjugate 29 may be bound to the additional surface region 26 by means of additional antibodies 27, for example. The additional antibodies 27 are then immobilised on the additional surface region 26, for example. The previous explanations regarding a preferred immunoassay reaction or other reaction for binding the additional analyte 28 or the additional optically detectable detection partner or conjugate 29 apply accordingly, in particular.

If the liquid 12 is not optically active in the sense of the invention, the light L1 radiated in through the liquid 12 can penetrate to the additional surface region 26 where it excites the additional conjugates 29. Accordingly, there is then an additional radiating of light L3 which can be additionally detected by the sensor 24 or by fluorescence measurement, as indicated in FIG. 3. In this case, a total signal is then obtained from the light L2 radiated out from the first surface region 19 and the light L3 radiated out from the second or additional surface region 26. If beforehand or afterwards the measurement is carried out only for the (first) surface region 19 as described with reference for FIG. 2, the presence of the additional conjugate 29 and hence of the additional analyte 28 can be determined qualitatively or quantitatively by corresponding subtraction.

The proposed use of the optically active liquid 12 may in particular suppress or filter out intrinsic or autofluorescent properties of wall material or other material and/or background influences. Furthermore, the optically active liquid 12 may reduce or substantially prevent negative influences of non-specific binding—such as binding of the conjugate 22/29 independently of the associated antibody 20/27 to other binding partners or surface regions—in optical examinations or measuring processes.

It should be noted that the optically active liquid may also act or be used as a so-called quencher or cut-off filter. The so-called quenching can prevent fluorophores from changing into the excited state or excited fluorophores from being changed into their basic state without radiation.

Basically it should be noted that different liquids 12 with different optical properties, i.e. for example an optically inactive liquid 12 and an optically active liquid 12 and/or, for example, differently optically active liquids 12, may be conveyed as desired one after another into the detection chamber 10 or different parts of the detection chamber 10 or over different surface regions 19, 26 which are to be investigated.

The present invention or the optically active liquid 12 can basically also be used when excitation with light L1 takes place but the signal from the sample 3 or analyte 21/28 or detection partner or conjugate 22/29 to be examined is not detected optically but by some other method, for example by electrical measurement or a change in resistance, a photothermic method or the like. In this case, a reaction is only started, for example, by light L1 being radiated in. In particular the detection is not carried out optically.

List of Reference Numerals

| | |
|---|---|
| 1 | Device |
| 2 | Sample holder |
| 3 | Sample |
| 4 | Channel |
| 5 | Mixing chamber |
| 6 | Receptacle |
| 7 | Detection liquid |
| 8 | Channel |
| 9 | Channel |
| 10 | Detection chamber |
| 11 | Reservoir |
| 12 | Washing liquid |
| 13 | Channel |
| 14 | Valve |
| 15 | Valve |
| 16 | Overflow reservoir |
| 17 | Lower part |
| 18 | Lid element |
| 19 | Surface region |
| 20 | Antibody |
| 21 | Analyte |
| 22 | Conjugate |
| 23 | Light source |
| 24 | Sensor |
| 25 | Dye, pigment, particle |
| 26 | Additional surface region |
| 27 | Additional antibodies |
| 28 | Additional analyte |
| 29 | Additional conjugate |
| D | Layer thickness |
| L1 | Light radiated in |
| L2 | Light radiated out |
| L3 | Light radiated out |
| S | Section line |

1. A method for the optical examination of a surface region (19) of a wall, preferably a reaction or immunoassay reaction associated with the surface region (19), particularly in an immunoassay, wherein the surface region (19) or a substance bound thereto is irradiated with light (L1) radiated in and, in particular, light (L2) radiated out is detected,
characterised in that
the surface region (19) is covered by an optically active liquid (12) which filters, reflects, scatters, polarises and/or absorbs light with a wavelength at least substantially corresponding to the light (L1, L2) which is radiated in and/or out.

2. The method according to claim 1, characterised in that UV light (L1) is radiated in.

3. The method according to claim 1, characterised in that the light (L1) is radiated in through the wall.

4. The method according to claim 1, characterised in that visible light (L2) is radiated out.

5. The method according to claim 1, characterised in that the light (L2) radiated out through the wall is detected.

6. The method according to claim 1, characterised in that the optically active liquid (12) contains a dye (25).

7. The method according to claim 1, characterised in that the optically active liquid (12) contains pigments and/or particles (25), particularly of titanium dioxide.

8. The method according to claim 1, characterised in that the optically active liquid (12) is a washing liquid or reaction liquid particularly for the formation and/or binding of the substance and/or for an immunoassay reaction.

9. The method according to claim 1, characterised in that the optically active liquid (12) forms an optically neutral background for the detection of the light (L2) radiated out, particularly for a measurement of fluorescence, and/or forms an optical filter for the light (L1, L2) behind the surface region (19).

10. The method according to claim 1, characterised in that the surface region (19) is covered by the optically active liquid (12) in a layer thickness (D) of more than 0.1 μm, preferably more than 1 μm, more particularly more than 10 μm, preferably more than 50 μm.

11. The method according to claim 1, characterised in that the substance is luminescent, particularly fluorescent, and/or the detection of the light (L2) radiated out is carried out as a measurement of fluorescence.

12. The method according to claim 1, characterised in that the substance, more particularly a complex of an analyte (21) and a conjugate (22), is or has been bound to the surface region (19) by means of an antibody (20) and/or in that the substance is an analyte (21) of a sample (3) that is to be investigated, a complex formed therefrom or a reaction product dependent thereon or a reagent.

13. The method according to claim 1, characterised in that the optically active liquid (12) selectively covers an additional surface region (26) opposite the surface region (19), in order to selectively prevent irradiation of the additional surface region (26) or a substance located thereon and/or radiation therefrom.

14. A device (1) having an in particular microfluidic detection chamber (10) which has a transparent wall with a surface region (19) on the chamber side, wherein the surface region (19) or a substance bound thereto can be irradiated with light (L1) radiated in, and/or light (L2) radiated out can be detected,
characterised in that
the surface region (19) is or can be covered by an optically active liquid (12) which filters, reflects, scatters, polarises and/or absorbs light with a wavelength at least substantially corresponding to the light (L1, L2) radiated in and/or out.

15. The device according to claim 14, characterised in that the device is or forms an immunoassay, in particular wherein the optically active liquid (12) is a washing liquid or reaction liquid for an immunoassay reaction.
